(19) United States
(12) Patent Application Publication
(10) Pub. No.: US 2014/0216406 A1
(43) Pub. Date: Aug. 7, 2014

(54) Combustion Method for Piston Combustion Engines

(71) Applicants: Tobias Weyand, Karlsruhe (DE); Friedrich Schmid, Korb (DE); Wilhelm Ruisinger, Fellbach (DE); Fabian Trapp, Stuttgart (DE); Thomas Koch, Pfinztal-Berghausen (DE); Johannes Ritzinger, Stuttgart (DE); Volker Heiderich, Winnenden (DE)

(72) Inventors: Tobias Weyand, Karlsruhe (DE); Friedrich Schmid, Korb (DE); Wilhelm Ruisinger, Fellbach (DE); Fabian Trapp, Stuttgart (DE); Thomas Koch, Pfinztal-Berghausen (DE); Johannes Ritzinger, Stuttgart (DE); Volker Heiderich, Winnenden (DE)

(73) Assignee: Daimler AG, Stuttgart (DE)

(21) Appl. No.: 14/234,003

(22) PCT Filed: Jun. 29, 2012
(86) PCT No.: PCT/EP2012/002745

§ 371 Date: Mar. 26, 2014

(30) Foreign Application Priority Data
Jul. 22, 2011 (DE) 10 2011 108 332.8

(51) Int. Cl. F02M 53/04

(52) U.S. Cl. CPC F02M 53/04
USPC 123/445

(57) ABSTRACT

A combustion method for reciprocating internal combustion engines, in particular diesel engines, whose fuel injection system operates with pre-injection involves two pre-injections during a cold start phase, which are carried out prior to reaching top dead center of a piston. A first pre-injection is performed at approximately 25° CA before top dead center and a second pre-injection is performed at approximately 5° CA before top dead center. A crank angle interval α of approximately 20° CA between the individual pre-injections and a crank angle interval β of approximately 5° CA between the second pre-injection and a main injection, are maintained independently of the rotational speed.

### BACKGROUND AND SUMMARY OF THE INVENTION

Exemplary embodiments of the present invention relate to a combustion method for a reciprocating internal combustion engine, in particular a diesel engine, whose fuel injection system operates with pre-injection. The invention further relates to a reciprocating internal combustion engine which operates using this type of combustion method.

German patent document DE 37 36 630 A1 discloses a generic combustion method for reciprocating internal combustion engines, in particular diesel engines, whose fuel injection system operates with pre-injection. Due to the fact that diesel engines must operate with a relatively low compression ratio and with fuels having a relatively low cetane number, they have ignition problems during a cold start phase, resulting in noise and pollutant emissions. As a result of the proposed combination of fuel injection with pre-injection as well as externally supplied ignition, the aim is to provide reliable, precisely defined ignition conditions over the entire operating range of the diesel engine that result in lower noise and pollutant emissions.

European patent document EP 0 534 491 A2 discloses a fuel injection control system, the aim of which is to facilitate starting of diesel engines. For this purpose the fuel injection control system injects a fuel pilot jet into a combustion chamber synchronously with a signal that indicates an angular position of the crankshaft of the diesel engine. After the fuel pilot jet has been injected, the fuel injection control system injects a fuel main jet in a larger quantity than that of the injected fuel pilot jet. Even when the rotational speed is low and is subjected to great changes, which occur frequently in particular in the cold start phase, the fuel pilot jet is reliably injected into the combustion chamber at a desired point in time by the fuel injection control system. However, in the cold start phase the fuel pilot jet is not only injected before the fuel main jet, but at the same time is also ignited in order to produce an easily combustible, triggering state in the combustion chamber. The subsequently injected fuel main jet may thus be easily ignited due to the triggering state in the combustion chamber, as the result of which the diesel engine may be reliably and securely started, and in particular the noise and pollutant emissions during the cold start phase may be reduced.

In general, diesel engines have the fundamental drawback of relatively high cylinder peak pressures. To avoid this, the compression ratio may be selected to be relatively low, which, however, once again has the disadvantage that during the cold start phase and under part load, difficulties may arise due to the ignition lag that is then particularly high, which on the one hand may result in noise generation, and on the other hand, high pollutant emissions of uncombusted hydrocarbons. However, similar problems may also arise during normal operation when fuels having unfavorable ignition characteristics are used. A proven approach for shortening the ignition lag is to carry out the pre-injection and precombustion of a certain quantity of fuel prior to the actual main fuel quantity, so that the pressure and temperature level in the cylinder may be significantly increased, and therefore better ignition conditions may be provided.

Therefore, for a combustion method and a reciprocating internal combustion engine of the generic kind, the present invention provides an improved or at least an alternative embodiment which is characterized by reliable starting, even at low ambient temperatures and with lower-quality fuel.

The present invention is based on the general concept, in a combustion method which operates with fuel pre-injection for reciprocating internal combustion engines, of carrying out during a cold start phase two pre-injections prior to reaching top dead center of a piston, namely, a first pre-injection at approximately 25° crank angle (CA) before top dead center and a second pre-injection at approximately 5° CA before top dead center. In contrast to combustion methods known heretofore, according to the invention a defined crank angle interval, not a time interval as previously, is now fixed between the individual pre-injections. The first pre-injection at approximately 25° CA before top dead center as well as the ignition of the two pre-injections increase the pressure prevailing in the combustion chamber and the prevailing temperature therein, which clearly improves the conditions for the mixture formation of the main injection, and in addition results in a decreased ignition lag, so that the injected quantity of fuel may be reacted and utilized much better. A crank angle interval α of approximately 20° CA between the individual pre-injections, and a crank angle interval β of approximately 5° CA between the second pre-injection and a main injection, are maintained independently of the rotational speed. In contrast, in combustion methods known heretofore from the prior art, fixed time intervals are typically maintained, which, however, with regard to mixture formation pose difficulties due to ignition lag. As a result of the fixed crank angle intervals α of approximately 20° CA and β of approximately 5° CA between the individual pre-injections and between the second pre-injection and the main injection, respectively, the pre-injections are generally also carried out independently of the rotational speed, since the first pre-injection always takes place at approximately 25° CA before top dead center, and the second pre-injection, at approximately 5° CA before top dead center. Using the combustion method according to the invention, the cold start phase may be reduced and thus, shorter starting times may be achieved, as well as reduction of noise and pollutant emissions during the cold start phase and during part load operation, in particular during idling.

The ignition conditions of a mixture in a combustion chamber of the reciprocating internal combustion engine are advantageously improved by means of a glow plug, at least during a cold start phase. Glow plugs are used in a known manner as electrical heating elements in combustion chambers of internal combustion engines, typically diesel engines, the glow plug being only briefly energized, and thus heated, during starting of the reciprocating internal combustion engine. In particular in diesel engines, these types of glow plugs may be used to facilitate ignition of the fuel-air mixture present in the combustion chamber, in that the ignition conditions of the fuel-air mixture are improved at least at the heated tip of the glow plug, which contributes to reliable and secure starting of the diesel engine. In particular, diesel fuel ignites only poorly during a cold start of the diesel engine, primarily due to cold walls of the combustion chamber and of the piston, which have a high specific heat capacity.

In addition, during the cold start the piston velocity produced by an electric starter is low, as a result of which the heat of compression is also reduced. In addition, the heat of compression is transferred comparatively quickly to the still cold cylinder walls and the still cold piston crown. Furthermore, different fuel qualities and in particular poorly ignitable fuels also contribute to the mentioned difficulties during a cold start of the diesel engine. For these reasons, use of electrically heated glow plugs in the combustion chamber has been known for quite some time, the glow plug being further energized, and thus further heated, at least for a certain precisely defined period after the cold start phase ends, in order to be able to further reduce the pollutant emissions in the exhaust gas.

The time period during which the glow plug is energized, and therefore also during which a vehicle battery is loaded to a considerable degree, may be limited to a few seconds in recent glow plugs. In general, two different types of glow plugs are used, namely, metal glow plugs and ceramic glow plugs, which differ in particular in the temperature of a glow shaft, which is 1000° C. for metal glow plugs and up to 1300° C. for ceramic glow plugs.

The present invention is further based on the general concept, in a reciprocating internal combustion engine which is known per se, in particular a diesel engine, to use a fuel injection system that, during a cold start phase, carries out a first pre-injection at approximately 25° CA before top dead center of the piston, and a second pre-injection at approximately 5° CA before top dead center, and maintains a crank angle interval α of approximately 20° CA between the individual pre-injections, and a crank angle interval β of approximately 5° CA between the second pre-injection and the main injection, independently of the rotational speed. The fuel injection system according to the invention operates according to the combustion method for reciprocating internal combustion engines stated and explained in the general concept, resulting in the advantages that are achievable by the combustion method according to the invention, in particular shorter starting times at low temperatures, reliable starting of the reciprocating internal combustion engine at very low temperatures down to −30° C., a reduction in starting time variations, and a reduction in noise during idling when the reciprocating internal combustion engine is cold. In particular the ability of the reciprocating internal combustion engine to reliably start at low outside temperatures of lower than −15° C. offers a significant advantage compared to combustion methods and reciprocating internal combustion engines known heretofore. Of course, due to increasingly stringent environmental constraints and emission standards, a reduction in pollutant emissions, in particular during the cold start phase, has a positive effect.

Further important features and advantages of the invention result from the drawings, and the associated description of the figures with reference to the drawings.

It is understood that the features stated above and to be explained below may be used not only in the particular stated combination, but also in other combinations or alone without departing from the scope of the present invention.

Preferred exemplary embodiments of the invention are illustrated in the drawings and explained in greater detail in the following description; identical, similar, or functionally equivalent components are denoted by the same reference numerals.

### BRIEF DESCRIPTION OF THE DRAWING FIGURES

The figures show the following, in each case schematically:

FIG. 1 shows a diagram for illustrating a pressure P in a combustion chamber of a reciprocating internal combustion engine as a function of a crank angle CA when carrying out a combustion method according to the invention, and for comparison, when carrying out a conventional combustion method; and

FIG. 2 shows a diagram for illustrating a start time tₛ as a function of a cold water temperature in conventional reciprocating internal combustion engines, and in reciprocating internal combustion engines operated using the combustion method according to the invention.

### DETAILED DESCRIPTION

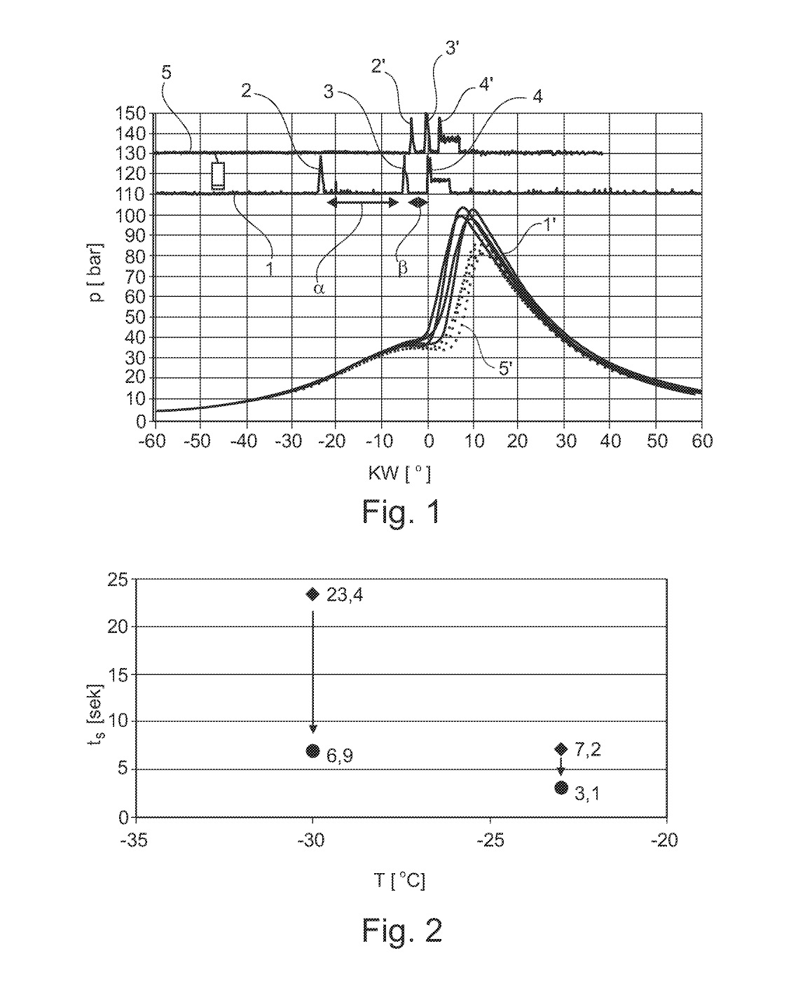

According to FIG. 1, the progression of a combustion method according to the invention for reciprocating internal combustion engines, in particular diesel engines, whose fuel injection system operates with two pre-injections may be read off on a curve 1. It is clearly apparent that a first pre-injection 2 takes place at approximately 25° CA before top dead center of a piston, whereas a second pre-injection 3 takes place at approximately 5° CA before top dead center. The top dead center is at 0° CA. A main injection 4 then takes place at top dead center. In the combustion method according to the invention, a crank angle interval α of approximately 20° CA is maintained between the two pre-injections 2, 3, while a crank angle interval β of approximately 5° CA is maintained between the second pre-injection 3 and the main injection 4. The crank angle interval α of approximately 20° C. between the two pre-injections 2, 3 and/or the crank angle interval β of approximately 5° between the second pre-injection 3 and the main injection 4 is/are maintained independently of the rotational speed.

A curve 5 shows a conventional combustion method in comparison to the curve 1, in which the crank angle intervals between the individual pre-injections 2′ and 3′ as well as between the second pre-injection 3′ and the main injection 4′ change as a function of the particular rotational speed of the reciprocating internal combustion engine. A pressure curve is illustrated as a function of the particular crank angle corresponding to the curves 1′ and 5′, whereby in this case the curve 1′ corresponds to the combustion method according to the invention, whereas the curve 5′ corresponds to a curve without use of the combustion method according to the invention. It is clearly apparent that at least the pressure in the combustion chamber may be greatly increased when the combustion method according to the invention is used, i.e., in curve 1′, compared to the curves 5′, as the result of which the ignitability of the mixture and thus also the ignition in the combustion chamber may be improved per se for the same quantity of fuel injected.

At least during a cold start phase of the reciprocating internal combustion engine, the ignition conditions of a mixture in a combustion chamber are improved by means of a glow plug which preglows for approximately 2 sec, for example. The glow plug is further energized for a defined period after the cold start phase in order to be able to further reduce pollutant emissions in particular.

In the diagram according to FIG. 2, a cold water temperature T in ° C. is plotted on the abscissa, and a start time tₛ of the reciprocating internal combustion engine is depicted on the ordinate, the start time essentially corresponding to the beginning of the starting operation until idling is reached. The square measuring points correspond to a reciprocating internal combustion engine with pre-injection which, however, does not operate using the combustion method according to the invention, whereas the circular measuring points stand for a reciprocating internal combustion engine that operates using the combustion method according to the invention. It is clearly apparent that at a cold water temperature T of −30° C., for example, a reduction in the start time tₛ from 23.4 sec to 6.9 sec, and thus to approximately 25% of the original start time tₛ required for conventional reciprocating internal combustion engines, may be achieved using the combustion method according to the invention. For comparatively warmer cooling water having a temperature T of approximately −23° C., the start time tₛ may be further reduced from 7.2 sec to 3.1 sec, and thus by more than half, using the combustion method according to the invention.

Using the combustion method according to the invention and a reciprocating internal combustion engine according to the invention that operates using this combustion method, much shorter starting times tₛ may thus be achieved, even at low temperatures T, it being possible to ensure reliable and secure starting of the reciprocating internal combustion engine in particular even at very low temperatures T of −30° C., for example, which heretofore has been possible only in rare instances. In addition, a reduction in the starting time variation may be achieved, as well as a reduction in noise and pollutant emissions of the reciprocating internal combustion engine during the cold start phase and during part load operation, in particular during idling. The two injections which take place according to the invention at 25° CA and 5° CA may increase the pressure and the temperature in the combustion chamber, and the conditions for the mixture formation of the main injection 4 may thus be greatly improved. Due to the improved mixture formation, in turn ignition lag is decreased and the injected quantity of fuel may be better reacted.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-6. (canceled)

7. A combustion method for a diesel engine with fuel injection system that operates with pre-injection, the method comprising:
performing, during a cold start phase, a first and second pre-injection prior to reaching top dead center of a piston,
wherein a first pre-injection at approximately 25° crank angle before top dead center and a second pre-injection at approximately 5° CA before top dead center, and
wherein a crank angle interval α of approximately 20° CA between the first and second pre-injections, and a crank angle interval β of approximately 5° CA between the second pre-injection and a main injection, are maintained independently of rotational speed.

8. The combustion method according to claim 7, further comprising:
energizing a glow plug during the cold start phase to improve ignition conditions of a mixture in a combustion chamber of the diesel engine.

9. The combustion method according to claim 8, further comprising:
energizing the glow plug for a defined period after the cold start phase in order to reduce pollutant emissions.

10. A fuel injection system for a diesel engine, wherein the fuel injection system is configured such that during a cold start phase the fuel injection system initiates a first pre-injection at approximately 25° CA before top dead center and a second pre-injection at approximately 5° CA before top dead center, and wherein the fuel injection system is configured to maintain a crank angle interval α of approximately 20° CA between the first and second pre-injections, and a crank angle interval β of approximately 5° CA between the second pre-injection and a main injection, independently of rotational speed.

11. The diesel engine according to claim 10, wherein for each combustion chamber at least one glow plug is provided, which is configured to improve ignition conditions of a mixture in the combustion chamber of the diesel engine, at least during a cold start phase.

12. A passenger vehicle or a utility vehicle, comprising:
a diesel engine configured to operate with pre-injection; and
a fuel injection system for a diesel engine, wherein the fuel injection system is configured such that during a cold start phase the fuel injection system initiates a first pre-injection at approximately 25° CA before top dead center and a second pre-injection at approximately 5° CA before top dead center, and wherein the fuel injection system is configured to maintain a crank angle interval α of approximately 20° CA between the first and second pre-injections, and a crank angle interval β of approximately 5° CA between the second pre-injection and a main injection, independently of rotational speed.
